(19) United States
(12) Patent Application Publication
(10) Pub. No.: US 2010/0162379 A1
(43) Pub. Date: Jun. 24, 2010

(54) UNSOLICITED COMMUNICATION MITIGATION

(75) Inventors: Steven J. Goldberg, Downingtown, PA (US); Kamel M. Shaheen, King of Prussia, PA (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/627,140

(22) Filed: Nov. 30, 2009

Related U.S. Application Data
(60) Provisional application No. 61/140,500, filed on Dec. 23, 2008.

(51) Int. Cl. G06F 21/00

(52) U.S. Cl. 726/12

(57) ABSTRACT

A method and apparatus for mitigating unwanted communication are disclosed. A request to establish communications is received at a first Protection Against Unsolicited Communications in Internet Protocol Multimedia Subsystem (PUC) server. The PUC server determines whether to block the communication. If the communication is blocked, the sender is informed and a record of the blocked communication may be stored. Alternatively, the communication may be delivered to a subsequent PUC server (along with appended information about the sender), the receiver or sent to storage.

### CROSS REFERENCE TO RELATED APPLICATION(S)

This application claims the benefit of U.S. Provisional Patent Application No. 61/140,500, filed Dec. 23, 2008, which is incorporated by reference as if fully set forth herein.

### FIELD OF INVENTION

This application is related to wireless communications.

### BACKGROUND

Unsolicited communication (UC), such as telemarketing telephone calls, and e-mail SPAM, are typically unwanted and may cause serious network problems. UC is expected to greatly increase due to the inexpensive implementation and execution promised by the Internet Protocol (IP) Multimedia Subsystem (IMS). The main problem is expected to come from SPAM over IP Telephony (SpIT). However, UC instant messages (SpIM) and other forms of UC are equally problematic. In IMS, a recipient is subject to UC inconveniences, and the network may expend a significant amount of its capability supporting nonproductive activities, either in the signaling and/or the media transport link layers.

Conventional methods for protection against UC do not provide optimal solutions. Such methods may include classifying communications (e.g., by, the identity of the sender, recipient, the time of day, subject, content type(s), or allowed lists and denied lists) and conveying these classifications to servers in the communication network. These servers then decide whether to allow specific communications to proceed beyond the requesting state.

Numerous potential senders of both desired and undesired communication (from the recipient's perspective) exist. If the arbitration (decision making) is completely pushed to the source, numerous entities may require and need to process information about the various classifications of acceptable and unacceptable communications. This likely may result in excessive memory and processor loading.

In addition, while some communications may be definable as universally unwanted, there are numerous instances where the acceptability of a communication is recipient dependant. In addition, classifying communication acceptability based on any sort of averaging of users' ratings is subject to illicit influences.

A method and apparatus are desired that provides effective protection against UC, but with acceptable cost, scalability, quality of service (QoS), and faithfulness to the desires of the message targets.

### SUMMARY

A method and apparatus for mitigating Unsolicited Communication (UC) are disclosed. A request to establish communications is received at a first Protection Against Unsolicited Communications (PUC) server. The PUC server determines whether to block the communication. If the communication is blocked, the sender is informed and a record of the blocked communication may be stored. Alternatively, the communication may be delivered to a subsequent PUC server (along with appended information about the sender) or to the receiver or sent to storage.

### BRIEF DESCRIPTION OF THE DRAWINGS

A more detailed understanding may be had from the following description, given by way of example in conjunction with the accompanying drawings wherein:

FIG. 1 shows example components of an example PUC system;

FIG. 2 shows an example of PUC logical flow among a plurality of servers;

FIG. 3 shows an example of desirable call signaling;

FIG. 4 shows an example of unanswered call signaling;

FIG. 5 shows an example where undesirable communication is unanswered; and

FIG. 6 shows an example where PUC process control occurs at a sender's PUC.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, a site controller, an access point (AP), or any other type of interfacing device capable of operating in a wireless environment. The messages in any of the embodiments described herein may include ratings. When referred to herein, the terminology “call” is used interchangeably with “communication” and includes any form of electronic information exchange. The terms “close” or “closest” do not necessarily refer to a distance measurement, but instead refer to the close or closest point in terms of signaling (e.g., the next entity that receives the signal).

In conventional protection against UC parlance, the intended receiving device of a communication is referred to as Alice and a desirable sender as Bob. A sender of an undesirable communication is referred to as Mallory. If a sender is either Bob or Mallory, the sender will be referred to as “Sender.” Alice, Bob, or Mallory may be wireless transmit/receive units (WTRUs), personal computers, or any other device capable of sending and receiving messages. The term “desirable” is interpreted as meaning Alice, and the network, find it generally acceptable that the communication be presented to Alice. Alice for instance might have criteria, such as lists of Senders or message types, for communications she generally likes to receive and are therefore desirable. Likewise, she may have criteria that prevent direct delivery of a communication, such as block or send the communication to voice mail, which makes the communication undesirable. Alice's home or residence networks may likewise have criteria for allowance or denial of communication completion.

The embodiments shown are by way of example. All described components may be in a single network or in a distributed or multiple network environment, there may even be multiple instances of each component (e.g., a database may be further distributed across multiple servers in one or more networks). Thus, a PUC server may be in at least one of a Sender's network, an intermediary network, a home network, or a presence network. Alternatively, every entity (e.g., the Sender, the receiver, the PUC server) may exist in a single network.

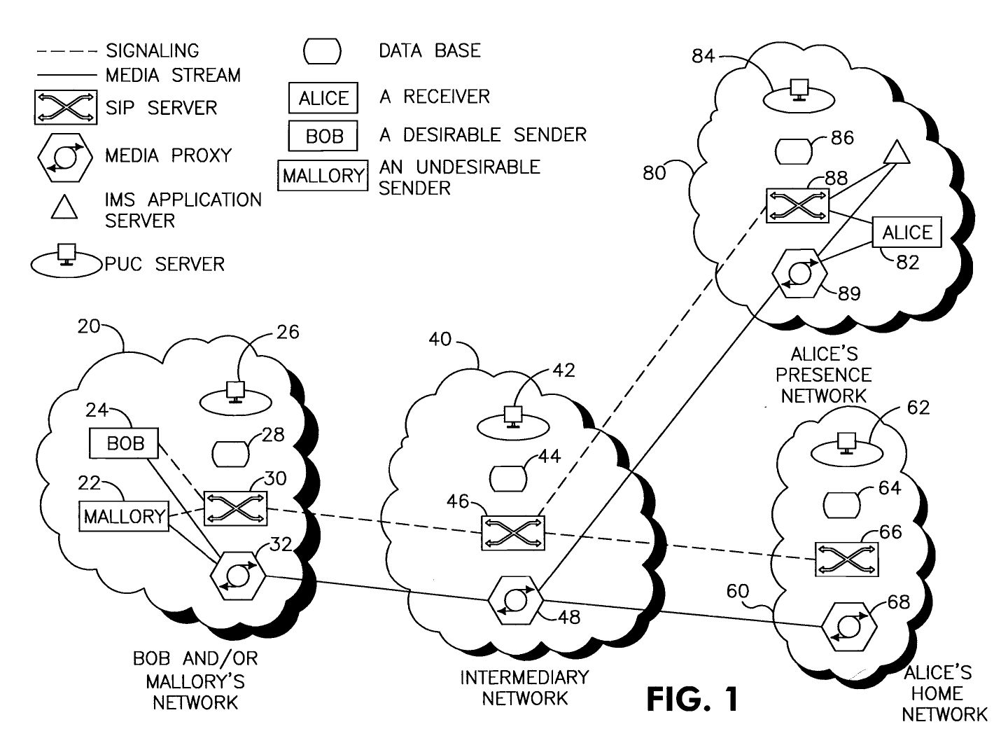

FIG. 1 shows an example of a diagram of a system for performing UC mitigation and illustrates Bob and/or Mallory's network 20, including Bob 24 and Mallory 22, a PUC server 26, a data base 28 (storage element), a session initiation protocol (SIP) server 30 (to facilitate receiving and sending messages), a media proxy 32 (for establishing a media connection for transmission of the message); an intermediary network 40, including a PUC server 42, a database 44, a SIP server 46, and a media proxy 48; Alice's home network 60, including a PUC server 62, a data base 64, a SIP server 66, and a media proxy 68; and Alice's presence network 80, including Alice 82, a PUC server 84, a data base 86, a SIP server 88 and a media proxy 89. In terms of minimizing the signaling and media stream communications from Mallory 22 to Alice 82, the closer the traffic is analyzed to Mallory 22, the better the expected result.

A more generalized diagram than that shown by FIG. 1 of a system performing UC mitigation may show multiple network clouds for potential source and destination resident networks, as well as intermediary and home networks. For example, Bob 24 and Mallory 22 may reside in different networks. Likewise, fewer distinct network clouds may be shown if the various logically distinct functions are actually in the same physical networks. A PUC server may comprise a processor, a transceiver, a database, a SIP server and a media proxy. Alternatively or in addition, a PUC server may include an interface to at least one of a database, SIP server, or media proxy server, wherein these devices may be anywhere in the network (or in multiple networks). For example, referring to FIG. 1, the intermediary network PUC server 42 includes a processor, a transceiver (not shown), a database 44, a SIP server 46, and a media proxy 48. Alternatively, PUC 42 may include an interface to at least one of a database, SIP server, or media proxy server, wherein these entities may be anywhere in the network (or in multiple networks). Moreover, the network or networks described above may include more, less, or multiples of the components noted above.

While the networks may be distinct, all of the entities including the PUC functions (performed by the PUC server) may be implemented in some subset of the networks (20, 40, 60, 80) shown in FIG. 1. For instance, the Sender (e.g., Bob 24 or Mallory 22), the receiver's home PUC server (e.g., Alice's home PUC server 62), and the receiver's presence server (e.g., Alice's presence PUC server 84) may all be the same network (e.g., the Sender, receiver, and PUC server may be in the same physical network). One skilled in the art will recognize that various expansions or contractions of the physical embodiments may be considered without exceeding the scope of the system for performing UC mitigation.

A PUC server may be aware of polices for the overall network, and for the devices within the network. Additionally a receiver (e.g., Alice 82) may determine her own unique criteria for control over communications delivery. Alternatively or in addition, network policies, for instance, may prohibit specific sources, disable some embedded functions, prompt the receiver (e.g., Alice 82) for some control option, redirect to a SPAM holding function, or perform other policy directed operations.

In a further example, specific receiver (e.g., Alice 82) actions taken by the receiver's home PUC server (e.g., Alice's home PUC 62) on her behalf may include checking her specific black or white lists, and directing response functions without immediately alerting the receiver (e.g., Alice 82). Examples of events that may not require immediate alerts include, but are not limited to: voice mail, e-mail to be handled later folders, or e-mail forwarding.

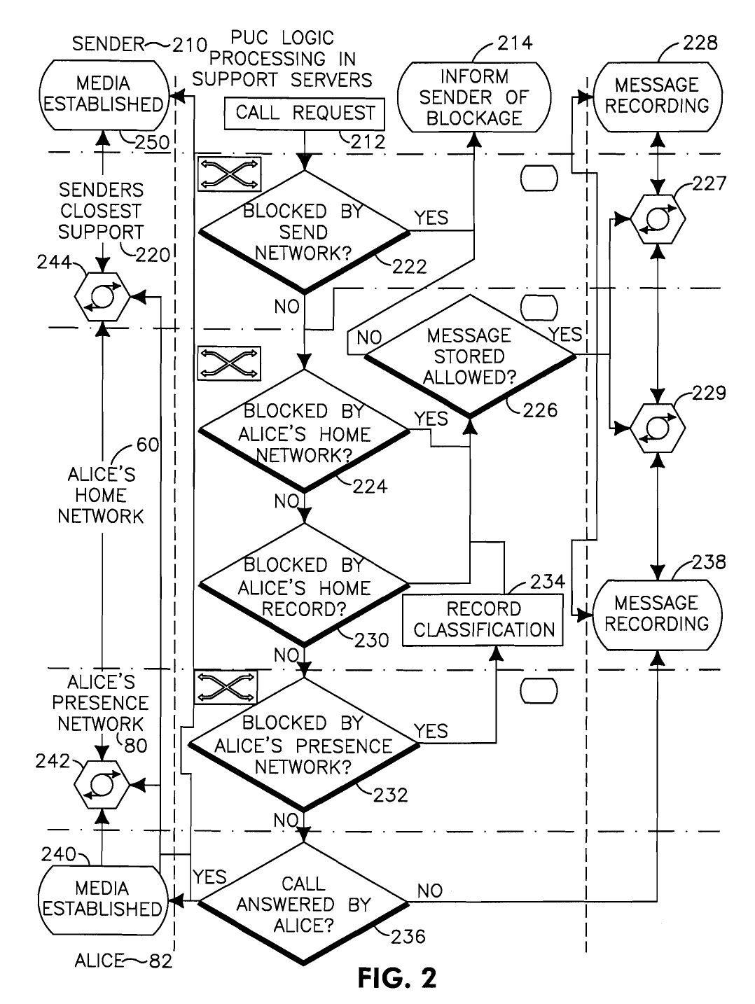

FIG. 2 shows an example of communication among the nodes of FIG. 1. As a message (e.g., call request) progresses from Sender to receiver, pertinent information about the Sender is appended to the message as it is forwarded from a first PUC server to a subsequent PUC server (when the message is not blocked). This information is used by the subsequent PUC server, in conjunction with any other information known or acquired by the subsequent PUC server, to determine whether or not to block the message. A Sender 210 (which may be Mallory 22 or Bob 24), the Sender's closest support network 220 (which may be Bob 24 or Mallory's 22 network 20 or an intermediary network 40), the receiver's home network (e.g., Alice's home network 60), the receiver's presence network (e.g., Alice's presence network 80), and the receiver (e.g., Alice 82). Limiting signaling exchanges between nodes may be particularly useful for real time audio communications. This is because delays in communication establishment may be very disruptive to people accustomed to a high QoS from traditional telephone networks. Servicing delays in processing nodes, and queuing delays in physical transport links, may be typically measured in tens of milliseconds, and may peak to hundreds of milliseconds.

Depending on which server is configured as the PUC server, the Sender's closest support PUC server may be in the Sender's network (e.g., Bob 24 or Mallory's 22 network 20) or in an intermediary network (e.g., intermediary network 40). The use of the media transport may not occur until authorized by the PUC server processing (performed by the PUC server). In addition, each PUC server (e.g., 26, 42, 62, and 84) may have access to the storage element (e.g., database) of the network (e.g., 28, 44, 64, or 86) it resides in. This storage (e.g., 28, 44, 64, or 86) may be unique to PUC services, or may be part of storage supporting other local functions.

Referring to FIG. 2, the Sender 210 initiates a call request 212, the PUC server for the Sender network (in Senders closest support network 220), evaluates the call request 212 and determines if the call request 212 should be blocked at 222 based on appropriate policy information, such as if the call request 212 is from an undesirable Sender (e.g., a Mallory 22). If the call request 212 is blocked, the Sender 210 is notified at 214.

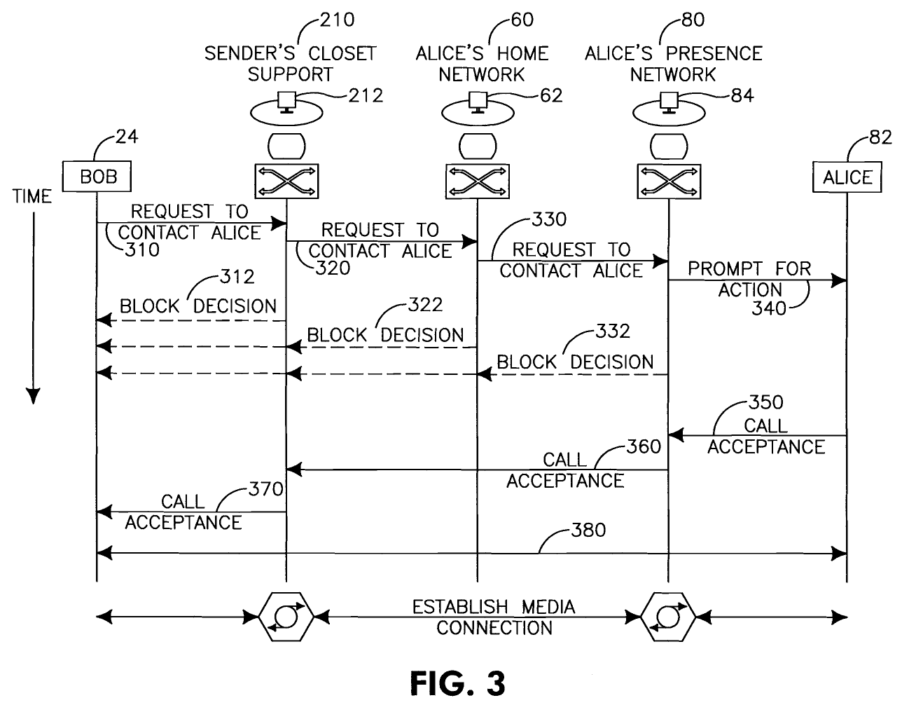

If the call request 212 is not blocked, the call request 212 is forwarded, along with pertinent information about the Sender 210 (e.g., Sender information, as described in reference to FIG. 3) to the receiver's home network (e.g., Alice's home network 60) and evaluated by the PUC server (e.g., PUC server 62) in the receiver's home network (e.g., Alice's home network 60) to determine if it should be blocked 224. If the call request 212 is blocked, the receiver's home network PUC server (e.g., Alice's home network PUC server 62) determines if the message may be stored 226 in a database (such as a voicemail folder). If so, the message is recorded 228 and stored. If the call request 212 is not blocked 224, the call request 212 is further evaluated with information in the receiver's home record (e.g., Alice's home record 230). If the call request 212 is blocked, the receiver's home network PUC server (e.g., Alice's home network PUC server 62) determines if the message may be stored 226 in a database (such as a voicemail folder). If so, the message is recorded 228 and stored.

If the call request 212 is not blocked at 224, the call request 212 is forwarded, along with any additional pertinent information about the Sender, to the receiver's presence network (e.g., Alice's presence network 80) and evaluated by the receiver's presence PUC server (e.g., Alice's presence PUC server 84) at 232. If the call request 212 is blocked, it is classified based on policy information (234) and its classification is stored (based on the receiver's PUC server (PUC server 84) processing of its respective information and any pertinent information passed along with the call request 212). The receiver's home network PUC server (e.g., Alice's home network PUC server 62) then determines if the message may be stored 226 in a data base (such as a voicemail folder). If so, the message is recorded 228 and stored. If the call request 212 is not blocked at 232, the call is answered by the receiver (e.g. Alice 82) at 236 and media is established between the receiver (e.g., Alice 82) at 240 and the Sender 210 at 250 via media proxy servers 242 and 244 and the call proceeds (completing the call).

FIG. 3 shows an example of a process for fulfilling a Sender's request for communication. A communications request 310 to contact the receiver (e.g., Alice 82) may be made to the closest PUC server (e.g., PUC server 210) supporting the Sender's presence network (e.g., Bob's presence network 20). Pertinent information concerning the Sender (e.g., Bob 24), such as identifiers or his home network, may accompany the request to communicate (310) with the receiver (e.g., Alice 82). The request 310 may also include information about the nature (type) of the communication, such as whether it is a voice over IP (VOIP) communication.

The sending PUC server (e.g., PUC server 212) may be dedicated to serving the Sender's network, or it may be the first PUC server encountered by the signaling as the signaling progresses (e.g., as the message or call request moves through the network). The sending PUC server (e.g., PUC server 212) examines the call request 310, comparing it with known data regarding the Sender's and target's information.

If the sending PUC server (e.g., PUC server 212) finds no reason to block the communication, appropriate (pertinent) information from the sending PUC server is appended to the original communication. Appropriate information may include PUC server identification, and classifications (e.g., based on policy information) known about the Sender. The appended communication 320 is then sent to the receiver's home network (e.g., Alice's home network 60). Based on the received information and the receiver's home records (e.g., Alice's home records), the home network's PUC server (e.g., in this case Alice's home network PUC server 62) decides whether the communication request should progress.

The home network PUC server (e.g., Alice's home network PUC server 62) may have information related to the receiver's presence network (e.g., Alice's Presence Network 80) cached in its memory (storage). Exploiting this information may result in stale data. While the odds of the visitor network changing its settings before the update is reflected in the home network is small, very large numbers of expected inquiries may result in stale data with some regularity. The viability of such a system is a measure of tolerance for these occurrences.

If the receiver's home network PUC server (e.g., Alice's home network PUC server 62) finds no reason to block the communication, the request 330 is forwarded to the receiver's presence network (e.g., Alice's presence network 80). The receiver's presence network PUC server (e.g., Alice's presence network PUC server 84) performs its own validation of the Sender's information, for example, using local network rules about the Sender or content, and then determines if the receiver (e.g., Alice 82) is still in the network.

If the receiver's presence network PUC server (e.g., Alice's presence network PUC server 84) finds no reason to block the communication, the receiver (e.g., Alice 82) is appropriately prompted (340) as to the incoming communication. An accepted communication 350 is reported to the receiver's network (e.g. Alice's Presence Network 80) and to the Sender's network (e.g., Bob's Network's PUC server 212) at 360, so that subsequent media link communications will be allowed. The Sender (e.g., Bob 24) is also informed of the accepted communication at 370. Signaling and media links are established at 380 to perform the actual communications (e.g., complete the call).

If any of the PUC servers finds reason to block the communication, the Sender (e.g., Bob 24) is notified (e.g., via 332, 322 and/or 312). Signaling terminates once the notification reaches the Sender (e.g., Bob 24), or sooner if the Sender (e.g., Bob 24) does not accept responses.

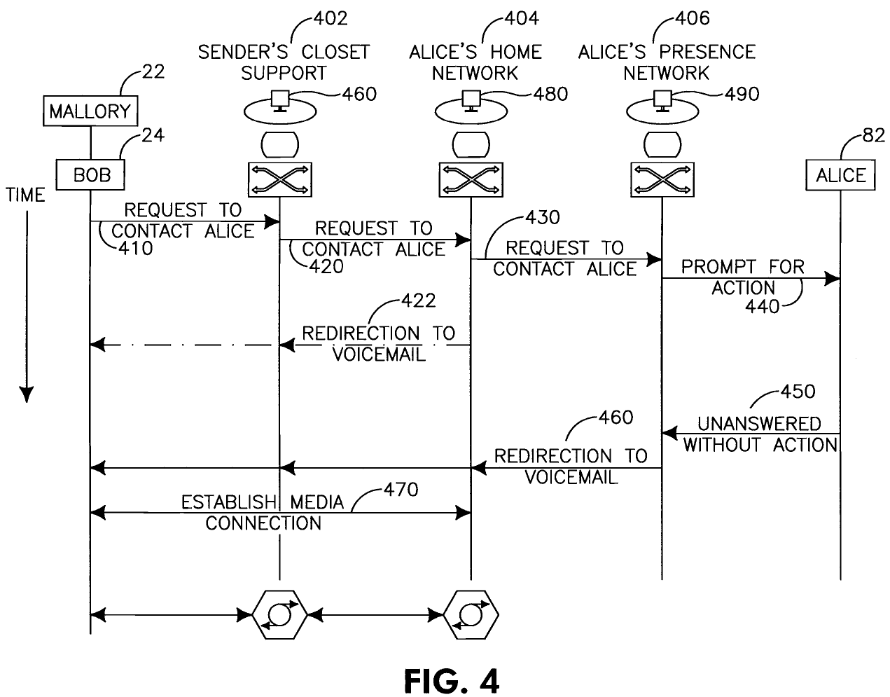

FIG. 4 shows a procedure where the communication reaches the receiver (e.g., Alice 82), but is not answered. The Sender may be either a Mallory 22 or a Bob 24. The process following the unanswered event depends on the nature of the communicator's identification. A communications request 410 may be made to the closest PUC server (e.g., PUC server 460) supporting Sender's presence network. Pertinent information concerning Sender, such as identifiers or home network, may accompany the request 410 (e.g., additional header information, or data packet) to communicate with Alice 82. The request 410 may also include information about the nature of the communication, such as whether it is a VOIP communication.

The PUC server may be dedicated to serving the Sender's network, or it may be the first PUC server encountered by the signaling as it progresses (e.g., as the call request moves through the network). The PUC server 460 examines the request, comparing it with known data regarding the Sender's and target's information.

If the PUC server 460 finds no reason to block the communication, appropriate information from the sending PUC server is appended to the original communication. Appropriate information may include the PUC identification, and classifications known for the Sender. The appended communication 420 is then sent to the receiver's home network (e.g., Alice's Home Network 404). Based on the received information and the receiver's home records (e.g., Alice's home records), the home network's PUC server (Alice's Home Network PUC Server 480) decides whether the communication request should progress.

The receiver's home network PUC server (e.g., Alice's home network PUC server 480) may have information related to the receiver's presence network (e.g., Alice's Presence Network 406) cached in its memory. Exploiting this information may result in stale data. While the odds of a visitor network changing its settings before the update is reflected in a home network is small, very large number of expected inquiries may result in stale data with some regularity. The viability of such a system therefore is a measure of tolerance for these occurrences.

If the receiver's home network PUC server (e.g., Alice's home network PUC server 480) finds no reason to block the communication, the receiver's home network PUC server (e.g., Alice's home network PUC server 480) identifies Mallory 22 as an originator (Sender) of a communication which should not disturb the receiver (e.g., Alice 82), but should be logged for later review. The Sender (e.g., Mallory 24) is informed (422) that the communication is being sent to storage (e.g., voicemail), and storage of a message from the Sender is obtained 470 (e.g., a media connection is established to store the voicemail). Alternatively, the request is forwarded to the receiver's presence network (e.g., the presence network for Alice 406). The receiver's presence PUC server (e.g., Alice's presence network PUC server 490) performs its own validation of the Sender's information. Using, for example, local network rules about the Sender or content. The receiver's presence PUC server (e.g., Alice's presence network PUC server 490) then determines if the receiver (e.g., Alice 82) is indeed still in the network.

If the receiver's presence network PUC server (e.g., Alice's Presence Network PUC server 490) finds no reason to block the communication, the receiver (e.g., Alice 82) is prompted (440) as to the incoming communication. The receiver (e.g., Alice 82) either declines to answer the communication 450, or selects the function to redirect it to storage 460 (e.g., voicemail). The Sender is informed (460) that the communication is being sent to storage (e.g., voicemail). Storage of a message from the Sender is obtained 470 (e.g., a media connection is established to store the voicemail).

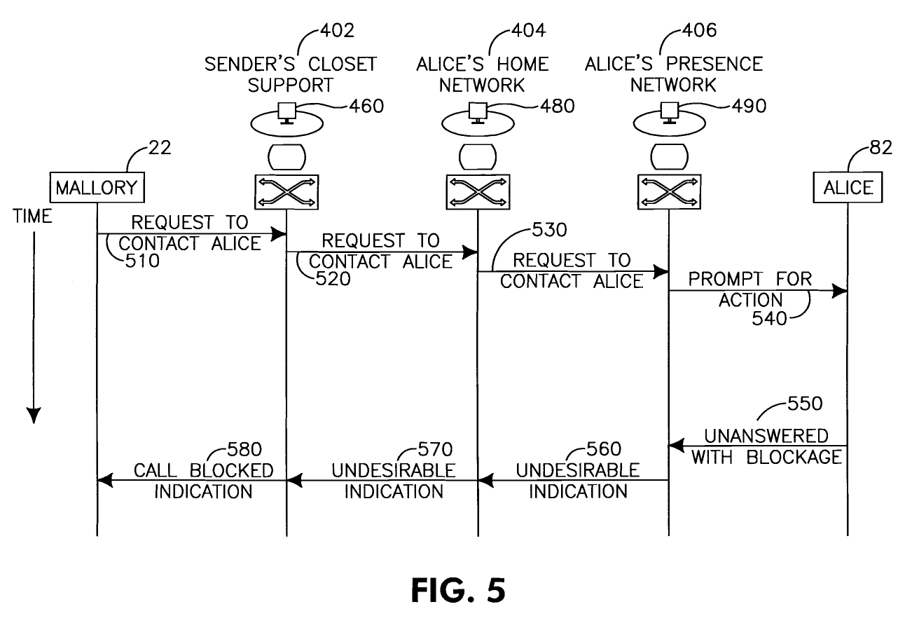

FIG. 5 shows a procedure where the communication reaches the receiver (e.g., Alice 82), but she determines it is from an undesirable Sender. This procedure is the same as the procedure described in FIG. 3, except that when Alice is prompted as to the incoming communication 540, the receiver (e.g., Alice 82) responds with a request that the caller is undesirable 550.

Next, the receiver's home network PUC server (e.g., Alice's home network PUC server 480), the PUC servers coordinating with Mallory's sending (e.g., 460 and 490), and Mallory 22 are all informed that Mallory 22 is labeled “Undesirable” and the communication is terminated 560. The label “Undesirable” is recorded in the receiver's home network PUC server (e.g., Alice's home network PUC server 480) records (e.g., stored in the corresponding data base). The receiver (e.g., Alice 82), at her discretion, may modify the indication at some later time. Storing “Undesirable” records in any PUC other than the receiver's home network PUC server (e.g., Alice's home network PUC server 480) may prevent the receiver (e.g., Alice 82) from editing the information such that it is updated in all pertinent databases.

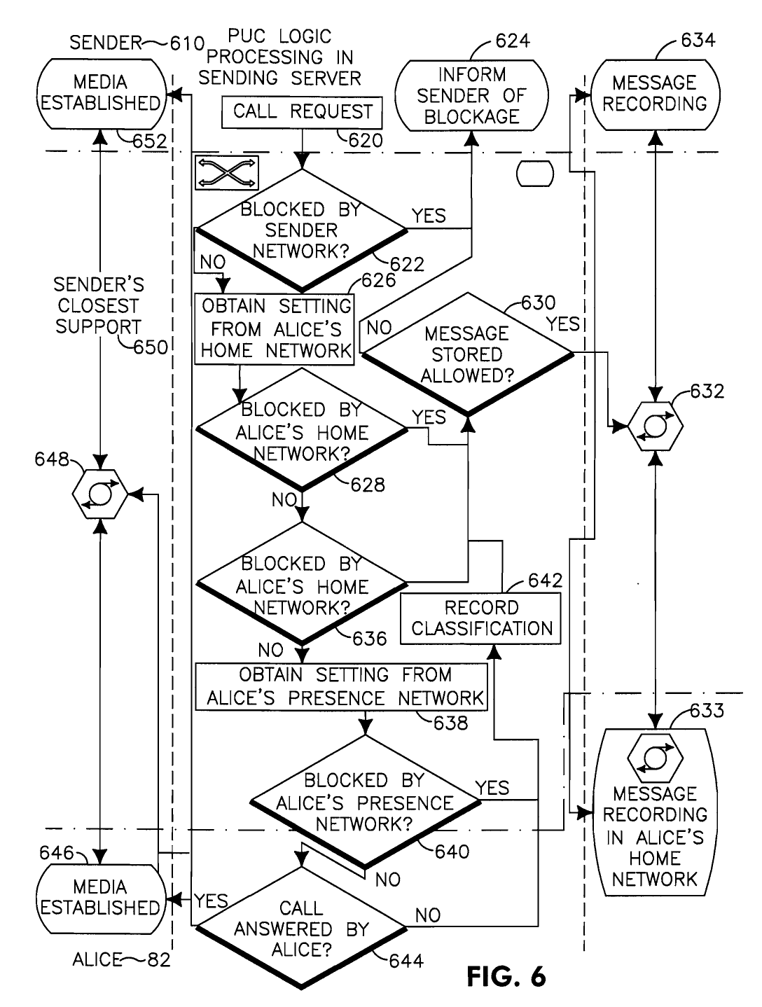

FIG. 6 shows an example of a Sender's server only procedure where process control occurs at the Sender's PUC server. This procedure is the same as that described in FIG. 2, except that requests are made to the Home and Presence servers for the information necessary to apply the PUC server logic, and the information is sent to the Sender's server for decision processing.

Referring to FIG. 6, the Sender 610 initiates a call request 620. The Sender's closest support PUC server 650 determines if the message is blocked by the Sender's network at 622. If the message is blocked, the Sender is informed of the blockage 624.

If the message is not blocked, a setting or policy is obtained from the receiver's home network PUC server (e.g., Alice's home network PUC server 480). Then the PUC Server (in the Sender's closest support network 650) determines whether to block the message based on combined policy information (628) (policy information is obtained and combined with information already known by the PUC server (e.g., stored in its respective database)). If the message is blocked at 628, the PUC server (in the Sender's closest support network 650) determines if message storage is allowed 630. If not, the Sender 610 is informed of the blockage. If so, the, message is recorded (634) via the media proxy server 632. If the message is not blocked at 628, the PUC server (in the Sender's closest support network 650) determines if the message is blocked by the receiver's home PUC server (e.g., Alice's home PUC 480) based on combined policy information (636). If so, the PUC server (in the Sender's closest support network 650) determines if message storage is allowed 630. If not, the Sender 610 is informed of the blockage. If so, the, message is recorded 634 via the media proxy server 632. If the message is not blocked by the receiver's home PUC server (e.g., Alice's home PUC 480), a setting or policy is obtained from the receiver's presence network PUC server (e.g., Alice's presence network PUC 490). The PUC server (in the Sender's closest support network 650) then determines if the message is blocked by the receiver's presence network PUC server (e.g., Alice's presence network PUC server 490) at 640. If the message is blocked at 640, the classification is recorded, the PUC server (in the Sender's closest support network 650) determines if message storage is allowed 630. If not, the Sender 610 is informed of the blockage. If so, the, message is recorded 633 via the media proxy 632.

If the message is not blocked at 640, the PUC server (in the Sender's closest support network 650) determines if the call is answered by the receiver (e.g., Alice 82) at 644. If the call is not answered by the receiver (e.g., Alice 82) at 644, the classification is recorded, the PUC server (in the Sender's closest support network 650) determines if message storage is allowed 630. If not, the Sender 610 is informed of the blockage. If so, the message is recorded 633 via the media proxy server 632. If the call is answered by the receiver (e.g., Alice 82), a media connection is established between the Sender 610 and the receiver (e.g., Alice 82) via a media proxy server 648 and the call proceeds (completing the call).

Alternatively, in addition to the procedures described in relation to FIGS. 2-6, to prevent spoofing, the PUC server may send enough information about the communication attempt to the Sender, and request confirmation that the Sender did send the request. If the Sender denies it is responsible (denies that it sent the request), the communication may be blocked. The occurrence of such a block may be recorded by the appropriate PUC servers, and may specifically be sent to the Home Network server of the spoofed caller.

The PUC servers may use this information to make an early determination in regards to the possible use of an entity as a Sender. As a result, a challenge may be automatic. If the number of communications from a Sender that are blocked exceeds a threshold, a ticket requesting corrective action from an automated or human authority may be issued.

### Embodiments

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for protecting against unsolicited communications comprising:
receiving a message by a first protection against unsolicited communications (PUC) server;
evaluating the message based on policy information;
blocking the message based on the evaluation of the message, wherein the evaluation is based on known or acquired information; and
forwarding the message with appended sender information on a condition that the message was not blocked, wherein the appended information is used to evaluate the message.

2. The method of claim 1, wherein policy information includes at least one of:
source prohibition information, disablement of a function, prompting information, or SPAM redirection information.

3. The method of claim 1, further comprising:
notifying a sender that the message was blocked.

4. The method of claim 1, wherein the PUC server is in at least one of:
a senders network, an intermediary network PUC, a home PUC server or a presence PUC server.

5. The method of claim 1, further comprising:
receiving the message by a second PUC server;
evaluating the message based on policy information;
blocking the message based on the evaluation of the message, and on a condition that storing is allowed, recording and storing a message in a database;
on a condition that the message is not blocked, performing a second evaluation based on home record information; and
on a condition that the message was not blocked, forwarding the message with appended sender information.

6. The method of claim 5, further comprising:
receiving the message by a third PUC server;
evaluating the message based on policy information;
blocking the message based on the evaluation of the message and storing a classification based on policy information, on a condition that storing is allowed, recording and storing a message in a database;
on a condition that the message is not blocked, determining whether the message was answered;
on a condition that the call was not answered, recording and storing the message;
on a condition that the call was answered, establishing a media connection; and
completing the call.

7. The method of claim 1, wherein the message includes at least one of identifiers, a sender's home network information, or type of communication.

8. The method of claim 1, wherein the first PUC server is dedicated to the sender's network or the first PUC server is the initial PUC server to receive the message.

9. The method of claim 1, further comprising:
receiving information, by each coordinating PUC server, that the message is from an undesirable sender; and
terminating the communication.

10. The message of claim 1, wherein process control occurs at a sender's PUC server.

11. The method of claim 1, wherein the message is a call request.

12. A protection against unsolicited communications (PUC) server comprising:
a transceiver configured to send and receive a message;
a processor configured to process the message;
the transceiver further configured to append sender information to the message;
the processor further configured to evaluate the message based at least in part on sender information;
a database configured to store information;
a session initiation protocol (SIP) server configured to facilitate receiving and sending the message; and
a media proxy server configured to establish a media connection for transmission of the message.

13. The PUC server of claim 12, further comprising:
an interface to at least one of the database, the SIP server, or the media proxy server, wherein these devices may be located anywhere in a network or in multiple networks.

14. The PUC server of claim 12, wherein the message is a call request.
